(19) United States
(12) Patent Application Publication
(10) Pub. No.: US 2008/0105192 A1
(43) Pub. Date: May 8, 2008

(54) Apparatus and Method for Identifying a Pop-Top Can

(76) Inventor: Keith E. Larson, Macomb, MI (US)

Correspondence Address: GREGORY T. ZALECKI, 12900 HALL ROAD, SUITE 400, STERLING HEIGHTS, MI, 48313, US

(21) Appl. No.: 11/557,147

(22) Filed: Nov. 7, 2006

(51) Int. Cl. G09F 9/00; B42D 15/00; B65D 17/34

(52) U.S. Cl. 116/307; 283/74; 220/269

(57) ABSTRACT

An apparatus for identifying a pop-top can having a pull-tab activated opening member is comprised of a label, an adhesive backing and identifying indicia. The label is sized and shaped such that it has two generally circular sections joined by a neck. The circular sections fit the contour of the free end of the pull-tab. The neck and the circular sections are shaped to allow the label to become affixed to the pull-tab by the mating of the adhesive surfaces of each circular section to each other through an opening in the pull-tab. The identifying indicia, which may be a colored surface or typographical characters, distinguish one apparatus from another. A pop-top can is identified by affixing an apparatus to the pull-tab of the can.

### BACKGROUND

Pop-top cans are commonly used to store and dispense beverages and other liquids. Pop-top cans are usually cylindrical and have a top. The top of the cans are equipped with a pull-tab and an opening member. Older types of pop-top cans have a removable opening member attached to a pull-tab. The pull-tab is pulled in order to remove the opening member from the top or lid of the can, thereby creating an opening to facilitate dispensing a liquid or beverage from the container. Modern types of pop-top cans have a pull-tab secured to the top or lid of the can with a rivet. The rivet permits the pull-tab to be pivoted such that it exerts a force upon the opening member of the can. This force causes the opening member to partially separate from the top or lid thereby creating an opening to facilitate dispensing a liquid or beverage from the container.

Many social occasions occur wherein a number of people gather together and consume beverages contained within pop-top cans. Although most people consuming beverages from pop-top cans within a social setting desire the exclusive use of their respective cans, this is often easier said than done. It takes a period of time for a beverage to be consumed from a pop-top can. It is not unusual for person to become separated from a pop-top can selected by that person. For example, the person may put the can down in one location and leave it there while using a restroom. A person may put the person's can down in one location and leave it there while socializing with others. A person may put the person's can down in one location and leave it there while going to a buffet table to obtain food and eat the food.

Many other occasions exist wherein a person may lose track of a pop-top can selected for beverage consumption. Many find it undesirable to risk drinking from another's pop-top can. Similarly, many find it undesirable to put their pop-top cans at risk of misidentification while they are separated from their pop-top cans. Diseases can be communicated from one person to another by two or more people drinking from the same can. This often leads to waste. Some people would rather discard a beverage when there is uncertainty as to whether or not it has been partially consumed by another because of misidentification.

Elastic sleeves may be placed over the free ends of pull-tabs of pop-top beverage cans to help identify the cans and associate them with unique users. The sleeves may be colored or contain other identifying indicia to reduce the potential for misidentification. Unfortunately, the sleeves may present a choking hazard to infants and toddlers because of their small size. Elastic sleeves are also relatively expensive to manufacture.

There is a need for an improved apparatus for identifying a pop-top can. The apparatus would have an adhesive backing. It would fit upon the pull-tab of a pop-top can. It would allow one pop-top can to be distinguished from a similar pop-top can. It should have a low manufacturing cost. It should not be susceptible to degradation and loss of tackiness due to contact with moisture or condensation.

### SUMMARY

An apparatus for identifying a pop-top can having a pull-tab activated opening member is comprised of a label, an adhesive backing and identifying indicia.

The label is shaped and sized to cover and generally follow the contour of the top side and the bottom side of the free end of the pull-tab. One side of the label has the adhesive backing on it. Identifying indicia are on the surface of the label which is opposite the adhesive backing.

Most pull-tabs have an opening near their free end. This opening can be used to provide enhanced adhesion of a label to a pull-tab. The label is shaped and sized such that it may be secured to the pull-tab by the mating of the adhesive backing of two portions of the label through the opening in the free end of the pull-tab. The label is used by folding it over the free end of a pull-tab such that two adhesive backed surfaces of the label mate with each other through the opening in the pull-tab.

Preferably, the label is shaped such that it has two generally circular sections joined by a neck. This results in a barbell shaped label. The generally circular sections are shaped to generally fit the contour of the free end of the pull-tab. The neck is shaped and sized to allow the generally circular sections to fit the contour of the free end and to allow the label to become affixed to the pull-tab by the mating of the adhesive surfaces of each generally circular section to each other through the opening in the free end of the pull-tab.

The identifying indicia on the surface of the label allow one apparatus to be distinguishable from another. The identifying indicia may be comprised of a colored surface. The identifying indicia may also be comprised of typographical characters.

In order to use the apparatus, the adhesive backed label is affixed to the free end of the pull-tab.

### DRAWINGS

These and other features, aspects, and advantages of the present invention will become better understood with regard to the following description, appended claims, and accompanying drawings where:

FIG. 1 is a perspective view of a pop-top can having an identifying apparatus affixed to its pull-tab.

FIG. 2 is an enlarged broken away perspective view of the pop-top can and identifying apparatus of FIG. 1.

FIG. 3 is a cross-sectional view of the identifying apparatus and pull-tab of FIG. 1.

FIG. 4 is a top plan view of a plurality of pop-top can identifying apparatus affixed to a nonstick peelable backing.

FIG. 5 is a perspective view of an apparatus for identifying a pop-top can having a pull-tab activated opening member.

### DESCRIPTION

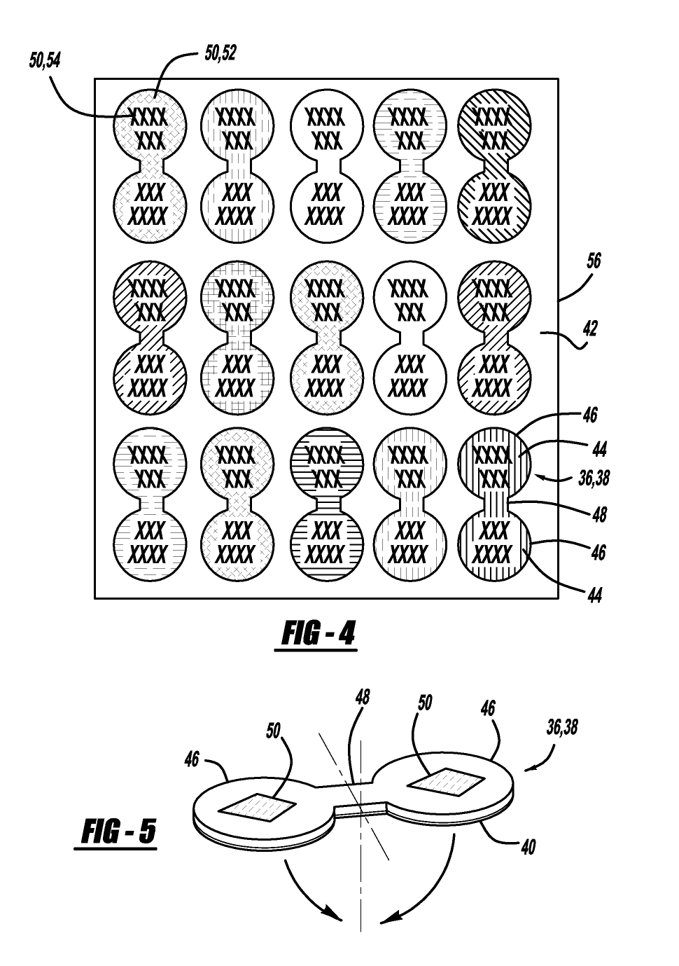

An apparatus 36 for identifying a pop-top can 20 having a pull-tab 26 activated opening member 22 is shown affixed to a pull-tab 26 in FIGS. 1-3. The apparatus 36 is shown in a perspective view in FIG. 5 and is shown affixed to a nonstick peelable backing 42 in FIG. 4.

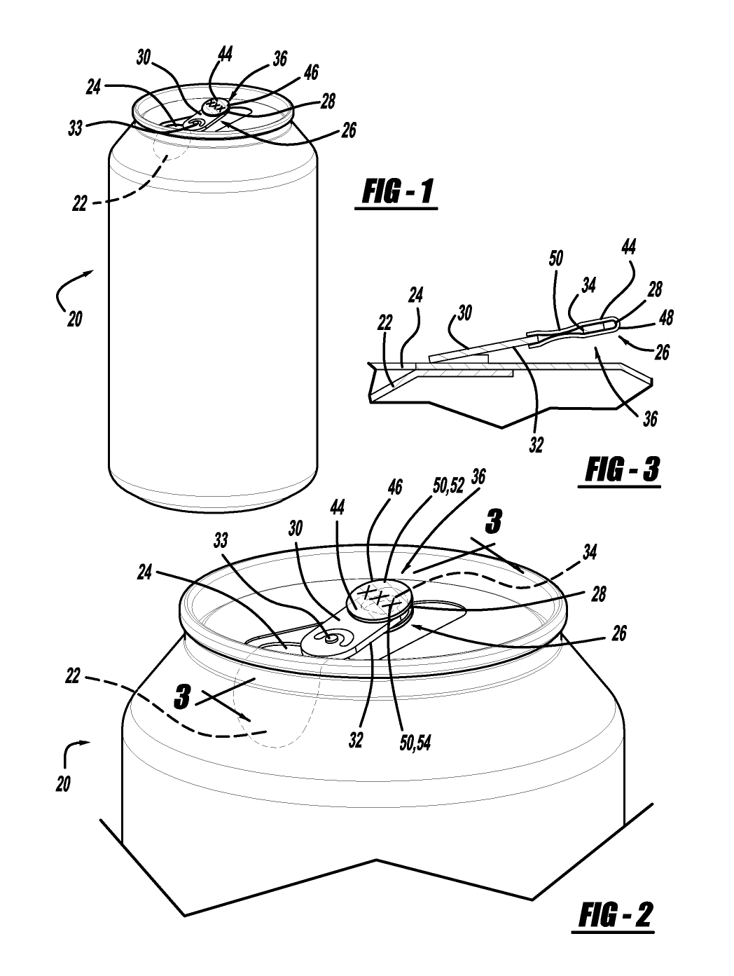

The top of a modern pop-top can 20 is shown in FIG. 2. A pull-tab 26 is used to apply an opening force to an opening member 22 of the pop-top can 20. The opening member 22 is a section of the top or lid of the can 20 which is circumscribed by a score line. The score line allows an opening force to depress the opening member 22 such that an opening 24 can be created within the top of the can 20. The opening force is provided by the pull-tab 26. The pull-tab 26 has a top side 30 and a bottom side 32. The pull-tab 26 is attached to the top of the can 20 with a rivet 33. The end of the pull-tab 26 which is distal to the rivet 33 is the free end 28 of the pull-tab 26. The free end 28 of a pull-tab 26 usually has a pull-tab opening 34, as shown in FIG. 2 and FIG. 3.

The apparatus 36 for identifying a pop-top can 20 having a pull-tab 26 activated opening member 22 can also be used on an older style pop-top can 20. An older style pop-top can 20 has a pull-tab 26 and an opening member 22. The pull-tab 26 is used to remove the opening member 22 from the can 20, thereby creating an opening 24 within the top of the can 20. The pull-tab of a modern pop-top can 20 remains attached to the can 20 after the can 20 is opened. The pull-tab 26 of an older style pop-top can 20 is usually removed from the can 20 after the can is opened. The apparatus 36 described herein is intended to be used upon the pull-tab 26 of a pop-top can 20 wherein the pull-tab 26 remains attached to the can 20. Therefore, unless the pull-tab 26 is only partially removed, use of the apparatus 36 on an older style pop-top can 20 should be limited to cans 20 which have not been opened. The best use is upon a modern style pop-top can 20 which has been opened.

An apparatus 36 for identifying a pop-top can 20 having a pull-tab 26 activated opening member 22 is comprised of a label 38, an adhesive backing 40 and identifying indicia 50.

The primary element of an apparatus 36 for identifying a pop-top can 20 having a pull-tab 26 activated opening member is a label 38. The label 38 is fabricated from a flexible material. Preferably, the label 38 is fabricated from paper. Plastic and vinyl materials may also be used. The label 38 should be shaped and sized to cover and generally follow the contour of the top side 30 and the bottom side 32 of the free end 28 of a pull-tab 26. The label 38 need not exactly follow the contour of the top side 30 and the bottom side 32 of the free end 28 of a pull-tab 26. This will allow the label to be used upon variously sized pull-tabs 26.

Preferably, the label 38 has two generally circular sections 46 joined by a neck 48. The generally circular sections 46 are shaped and sized to fit the contour of the free end 28 of the pull-tab 26 and to allow the label 38 to become affixed to the pull-tab 26 by the mating of adhesive surfaces of each generally circular section 48 to each other through the opening 24 in the free end 28 of the pull-tab 26, as shown in FIG. 2 and FIG. 3. The neck 48 is also shaped and sized to allow the generally circular sections 46 to fit the contour of the free end 28 of the pull-tab 26 and to allow the label 38 to become affixed to the pull-tab 26 by the mating of the adhesive surfaces of each generally circular section 46 to each other through the opening 24 in the free end 28 of the pull-tab 26. Thus, the preferred embodiment of the apparatus 36 is barbell shaped, as shown in FIG. 5.

The label 38 has an adhesive backing 40. Preferably, the adhesive backing 40 is moisture resistant. The adhesive backing 40 should be covered by a nonstick peelable backing 42. This will permit the apparatus 36 to be handled before use without the adhesive backing 40 sticking to unintended surfaces, such as clothing and furniture. A plurality of apparatus 36 can be attached to a nonstick peelable backing 42 such that the nonstick peelable backing 42 covers the adhesive backing 40 of each apparatus 36 and forms a sheet 56 of labels, as shown in FIG. 4. This will permit a user to have easy access to one or more apparatus 36 and also permit easy storage of the apparatus 36 in locations such as clothing pockets, drawers and automobile glove boxes. 40 apparatus 36 can be easily placed upon one piece of nonstick peelable backing 42. These 40 apparatus 36 could be arranged into four strips of 10 apparatus 36, wherein each strip contains identically marked apparatus 36.

One surface of the label 38 has the adhesive backing 40 on it. The surface 44 of the label 38 which is opposite the adhesive backing 40 has the identifying indicia 50 on it, as shown in FIG. 2, FIG. 4 and FIG. 5. The identifying indicia 50 allow one labeled container to be distinguished from another. The label 38 may have a surface 44 opposite the adhesive backing 40 which is a white surface. Even a white surface is considered to have identifying indicia 50 because such a surface can be distinguished from colored and marked surfaces. The identifying indicia 50 may simply consist of a colored surface 52. Apparatus 36 with colored surfaces 52 consisting of differing colors are easily distinguishable from each other because of those differing colors. For example, one user may identify a pop-top can 20 with a red colored surface 52, while another user identifies a pop-top can 20 with a green colored surface 52. The green and red colored labels 38 are easily distinguishable from each other when a user attempts to identify a previously marked pop-top can 20. Alternatively, the identifying indicia 50 may consist of typographical characters. For example, an apparatus 36 may be imprinted with a user's initials or name. The apparatus 36 may also be imprinted with one or more numbers to distinguish it from other apparatus 36 having different numbers or no numbers at all. The identifying indicia 50 can consist of almost any visual scheme which can be applied to the label 38. The visual scheme used can also be one that is unique for an individual beverage manufacturer or distributor.

The apparatus 36 is used to implement a method for identifying a pop-top can 20. A pop-top can 20 having a pull-tab 26 activated opening member 22 is selected. An apparatus 36 as described is selected. The apparatus 36 is affixed to the free end 28 of the pull-tab 26 by mating the adhesive backing 40 of the label 38 to the free end 28 of the pull-tab 26. If a barbell shaped apparatus 36 is used with a pull-tab 26 having a pull-tab opening 34, the generally circular sections 46 of the apparatus are folded over the free end 28 of the pull-tab 26 at the neck 48 such that the adhesive backing 40 on each folded section of the label 38 mates at the pull-tab opening 34, as shown in FIG. 2 and FIG. 3. This will provide enhanced adhesion of the apparatus 36 to the pop-top can 20 as compared to simply applying a sticker to the barrel portion of the can 20. It is not unusual for the barrel of a pop-top can 20 to contain moisture. This moisture can be the result of atmospheric condensation upon the can 20, the result of storing the can 20 in a wet environment such as a cooler or as a result of liquid within the container 20 finding its way onto the barrel of the can 20. If a sticker is applied to a moisture laden barrel portion of a can 20, the sticker may fall away because the moisture interferes with the ability of the sticker adhesive to adhere to the can 20. This problem does not exist for the apparatus 36 described herein when the apparatus 36 is folded over the opening 34 located at the free end 28 of the pull-tab 26. The pull-tab opening 34 contains no moisture because it provides no surface upon which moisture can accumulate. Therefore, it should be clear that when an apparatus 36 is attached to a pull-tab 26 such that two adhesive backed surfaces 40 contact each other at the pull-tab opening 34, the result is superior adhesion between the apparatus 36 and the pop-top can 20.

The apparatus 36 used to implement the method for identifying a pop-top can 20 is not required to have two generally circular sections 46 and is not required to cover and generally follow the contour of the top side 30 and the bottom side 32 of the free end 28 of the pull-tab 26. For example, the label 38 may be comprised of a triangular, rectangular or square shape. The method does require that the apparatus 36 be adhesively affixed to the pull-tab 26. The apparatus 36 may be adhesively affixed to the pull-tab 26 without mating two portions of the adhesive backing 40 to each other through the opening the 34 in the pull-tab 26. The apparatus 36 may be attached to the pull-tab 26 in a flag like fashion. For example, an apparatus 36 having two circular sections 46, as described, may be looped through a pull-tab opening 34 such that the adhesive backings 40 of the two circular sections mate while the two circular sections 46 remain external to the periphery of the pull-tab 26, and while the neck 48 of the apparatus 36 contacts the outer periphery of the opening 34 of the pull-tab 26, but portions of the neck 48 remain internal to the periphery of the pull-tab 26. In other words, the apparatus 36 can be looped through the opening 34 of the pull-tab 26 such that the circular sections 46 are affixed to the pull-tab 26 in a flag like configuration external to the pull-tab 26.

This invention also encompasses a marked beverage container. A marked beverage container is a pop-top can 20 having a pull-tab 26 activated opening member 22 with an apparatus 36, as described, attached to it. The adhesive backed label 38 is affixed to the free end 28 of the pull-tab 26 to create a marked beverage container.

The apparatus 36 for identifying a pop-top can 20 having a pull-tab 26 activated opening member 22 is superior to currently known devices for identifying pop-top cans 20. It fits upon the pull-tab 26 of a pop-top can 20, rather than upon the barrel portion of the can 20. It permits one pop-top can 20 to be distinguished from a similar pop-top can 20. The apparatus 36 has a low manufacturing cost. It is not susceptible to degradation and loss of tackiness or adhesion due to contact with moisture or condensation. The apparatus 36 does not present a choking hazard to infants and toddlers. The apparatus 36 can be distributed in bulk as sheets 56 of labels.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An apparatus for identifying a pop-top can having a pull-tab activated opening member, said apparatus comprising:
(a) a label shaped and sized to cover and generally follow the contour of the top side and the bottom side of the free end of the pull-tab;
(b) an adhesive backing on the label; and
(c) identifying indicia on the surface of the label which is opposite the adhesive backing.

2. The apparatus for identifying a pop-top can having a pull-tab activated opening member of claim 1, wherein the label is shaped and sized such that the label may be secured to the pull-tab by the mating of the adhesive backing of two portions of the label through an opening in the free end of the pull-tab.

3. The apparatus for identifying a pop-top can having a pull-tab activated opening member of claim 2, wherein the label is shaped such that it has two generally circular sections joined by a neck, wherein the generally circular sections are shaped to generally fit the contour of the free end of the pull-tab and wherein the neck is shaped and sized to allow the generally circular sections to fit the contour of the free end and to allow the label to become affixed to the pull-tab by the mating of the adhesive surfaces of each generally circular section to each other through the opening in the free end of the pull-tab.

4. The apparatus for identifying a pop-top can having a pull-tab activated opening member of claim 3, wherein the identifying indicia are comprised of a colored surface.

5. The apparatus for identifying a pop-top can having a pull-tab activated opening member of claim 3, wherein the identifying indicia are comprised of typographical characters.

6. A beverage container comprising:
(a) a pop-top can having a pull-tab activated opening member; and
(b) an apparatus for identifying a pop-top can having a pull-tab activated opening member, said apparatus comprising:
(i) a label shaped and sized to cover and generally follow the contour of the top side and the bottom side of the free end of the pull-tab;
(ii) an adhesive backing on the label; and
(iii) identifying indicia on the surface of the label which is opposite the adhesive backing;
(c) wherein the adhesive backed label is affixed to the free end of the pull-tab.

7. The beverage container of claim 6, wherein the label is shaped and sized such that the label may be secured to the pull-tab by the mating of the adhesive backing of two portions of the label through an opening in the free end of the pull-tab.

8. The beverage container of claim 7, wherein the label is shaped such that it has two generally circular sections joined by a neck, wherein the generally circular sections are shaped to generally fit the contour of the free end of the pull-tab and wherein the neck is shaped and sized to allow the generally circular sections to fit the contour of the free end and to allow the label to become affixed to the pull-tab by the mating of the adhesive surfaces of each generally circular section to each other through the opening in the free end of the pull-tab.

9. The beverage container of claim 8, wherein the identifying indicia are comprised of a colored surface.

10. The beverage container of claim 8, wherein the identifying indicia are comprised of typographical characters.

11. A method for identifying a pop-top can comprising:
(a) selecting a pop-top can having a pull-tab activated opening member;
(b) selecting an apparatus for identifying a pop-top can having a pull-tab activated opening member, said apparatus comprising:
(i) a label shaped and sized to cover and generally follow the contour of the top side and the bottom side of the free end of the pull-tab;
(ii) an adhesive backing on the label; and
(iii) identifying indicia on the surface of the label which is opposite the adhesive backing; and
(c) affixing the apparatus for identifying a pop-top can to the free end of the pull-tab by mating the adhesive backing of the label to the free end of the pull-tab.

12. The method for identifying a pop-top can of claim 11, wherein the label is shaped and sized such that the label may be secured to the pull-tab by the mating of the adhesive backing of two portions of the label through an opening in the free end of the pull-tab.

13. The method for identifying a pop-top can of claim 12, wherein the label is shaped such that it has two generally circular sections joined by a neck, wherein the generally circular sections are shaped to generally fit the contour of the free end of the pull-tab and wherein the neck is shaped and sized to allow the generally circular sections to fit the contour of the free end and to allow the label to become affixed to the pull-tab by the mating of the adhesive surfaces of each generally circular section to each other through the opening in the free end of the pull-tab.

14. The method for identifying a pop-top can of claim 13, wherein the identifying indicia are comprised of a colored surface.

15. The method for identifying a pop-top can of claim 13, wherein the identifying indicia are comprised of typographical characters.

16. The apparatus for identifying a pop-top can having a pull-tab activated opening member of claim 3, further comprising a nonstick peelable backing covering the adhesive.

17. A method for identifying a pop-top can comprising:
(a) selecting a pop-top can having a pull-tab activated opening member;
(b) selecting an apparatus for identifying a pop-top can having a pull-tab activated opening member, said apparatus comprising:
(i) a label shaped and sized to attach to the pull-tab;
(ii) an adhesive backing on the label; and
(iii) identifying indicia on the surface of the label which is opposite the adhesive backing; and
(c) adhesively affixing the apparatus for identifying a pop-top can to the pull-tab.
